(19) United States
(12) Patent Application Publication
(10) Pub. No.: US 2007/0174548 A1
(43) Pub. Date: Jul. 26, 2007

(54) [MEMORY CARD WITH IDENTIFIER]

(75) Inventor: Chih-Ling Wang, TAIPEI (TW)

Correspondence Address: JIANQ CHYUN Intellectual Property Office;7F.-1, No. 100, Roosevelt Rd., Sec. 2, Taipei, 100, TW

(73) Assignee: PHISON ELECTRONICS CORP., Chutung Town, Hsinchu Hsien. (TW)

(21) Appl. No.: 11/162,091

(22) Filed: Aug. 29, 2005

(51) Int. Cl. G06F 12/00

(52) U.S. Cl. 711/115; 711/103

(57) ABSTRACT

A memory card with identifier is provided. The memory card comprises a microcontroller and a flash memory. The microcontroller is connected to a flash memory transmission interface and a memory card transmission interface, wherein the memory card transmission interface is further connected to a host end. The flash memory is connected to the flash memory transmission interface. The microcontroller comprises a smartcard engine for matching a key of the host end with a key stored in the flash memory, wherein when the keys of the host end and the flash memory matches, the smartcard engine processes encrypting/decrypting of data to the flash memory, and wherein when the keys of the host end and the flash memory mismatches, the memory card rejects the host end from processing retrieval/storage of data to the flash memory.

### BACKGROUND OF THE INVENTION

1. Field of the Invention

The present invention generally relates to a memory card with identifier, and more particularly to a memory card comprising a smartcard engine for identifying the user and encrypting/decrypting data.

2. Description of the Related Art

As trend of computer development towards more powerful calculation capability, fast processing speed and small size, correspondingly, the number of the communication ports for a computer connecting to the peripheral devices, such as memory storage device, hard disk and CD ROM, must reduced. The external BUS may be a solution for reducing the number of communication ports, and this would indirectly make the use of memory card more popular. Data may be retrieved from the computer or PDA and stored into the memory card. Likewise, data stored in the memory card may be read by using the computer or the PDA. This would also allow the electronic devices to be lighter, thinner, shorter and smaller. However, small size electronic device may be easily misplaced; and if important data stored in the small size electronic device would be more serious when the electronic device is misplaced.

Accordingly, to protect important data some manufacturers invented a security system which allows access to the important data using a password, however, this method could not encrypt the important data in the memory card. With the progressive development of technology, password cannot effectively protect the important data as hackers can use some special tool to access the important data stored in the flash memory.

Therefore, how to overcome the above mentioned problems is important issue for the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a memory card with identifier.

According to an aspect of the present invention, the memory card comprises a smartcard engine to identify the user for protecting data stored therein. The smartcard engine is adopted for encrypting/decrypting data to prevent the unauthorized user to retrieve data stored in the memory card.

### BRIEF DESCRIPTION OF THE DRAWING

FIG. 1 is a block diagram of a memory card according to an embodiment of the present invention.

FIG. 2 is a block diagram of a flash memory of a memory card according to an embodiment of the present invention.

FIG. 3 is a process flowchart of a memory card according to an embodiment of the present invention.

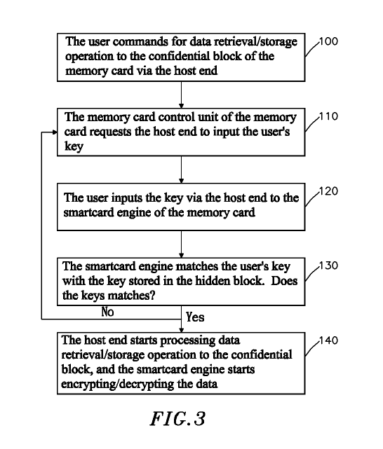

### DETAILED DESCRIPTION OF THE PREFERRED EMBODIMENTS

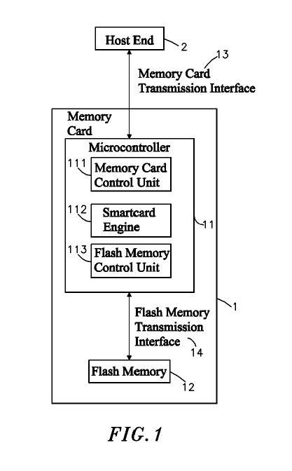

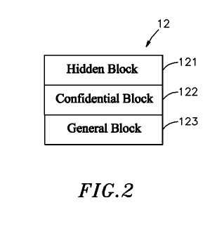

Referring to FIG. 1 and 2, a memory card 1 with identifier of the present invention comprises a microcontroller 11, a flash memory 12, a memory card transmission interface 13 and a flash memory transmission interface 14.

The microcontroller 11 comprises a memory control unit 111, a smartcard engine 112 and a flash memory control unit 113. The memory card control unit 111 is adopted for controlling the operation of the memory card 1. The smartcard engine 112 is adopted for matching a key stored in the flash memory 12 with a key of the host end, and for encrypting/decrypting data stored in the flash memory 12. The encrypting/decrypting method may be comprised of advanced encryption standard (AES), data encryption standard (DES), Rivest Shamir Adleman encryption (RSA) or triple data encryption algorithm (3DES). The flash memory control unit 113 is adopted for processing data retrieving and storing operation for the flash memory 12.

The flash memory 12 is capable of storing data, and may be comprised of NOR, NAND or AND type. The flash memory 12 comprises a hidden block 121, a confidential block 122 and a general block 123. The hidden block 121 is designed for denying data reading and the key of the memory card 1 is stored therein. The confidential block 122 is designed for retrieving/storing data in the flash memory 12 only when the smartcard engine 112 matches keys of a host end 2 with the memory card 1. The general block 123 is designed for processing retrieving/storing operation of any users without any request.

The memory card transmission interface 13 is connected the microcontroller 11 to the host end 2 for data transmission there-between. The memory card transmission interface 13 may be comprised of SD memory card transmission interface, MMC memory card transmission interface or CF memory card transmission interface.

The flash memory transmission interface 14 is connected the microcontroller 11 to the flash memory 12 for data transmission there-between. The flash memory transmission interface 14 may be comprised of NOR, NAND or AND type.

When the host end 2 retrieves the data stored in the confidential block 122 of the flash memory 12 of the memory card 1, the memory card control unit 111 of the memory card 1 requires the host end 2 to input a user's key. Meanwhile, the key inputted from the host end 2 is transmitted to the smartcard engine 112 via the memory card transmission interface 13, and the smartcard engine 112 matches the key received from the memory card transmission interface 13 with the key stored in the flash memory 12, wherein when the key mismatches with the key stored in the flash memory 12, the memory card control unit 11 rejects the host end 2 for processing data retrieving/storing operation to the confidential block 122. On the other hand, when the key matches with the key stored in the flash memory 12, the host end 2 is allowed to process data retrieval/storage operation to the confidential block 122. Furthermore, when the host end 2 reads data stored in the confidential block 122 after the keys are properly matched, the smartcard engine 112 decrypts the data and then transmits to the host end 2 via the memory card transmission interface 13. When the host end 2 writes data into the confidential block 122, the smartcard engine 112 encrypts data and then stores into the confidential block 122.

If any unauthorized user wants to steal the data stored in the confidential block 122 of the memory card 1, they cannot retrieve the data in the confidential block 122 without the key of the authorized user. Even when the data in the confidential block 122 is stole by using special tools; the data remain encrypted and cannot be read. Thus, the important data or program can be effectively protected.

Furthermore, the smartcard engine 112 may further comprise functions of a prepaid card, ATM card, identification and digital signature. Thus, when the memory card 1 is connected to the host end 2, the user can purchase, add value and verify identity over the network via the host end 2. The host end 2 may be a computer, a cellular phone or a PDA.

Additionally, the memory card 1 may be a secure digital (SD) card, a multi media card (MMC) card or a compact flash (CF) card.

Referring to FIG. 1, 2 and 3, when the host end 2 requests for processing data retrieval/storage operation to the confidential block 122 of the flash memory 12 in the memory card 1, the process flow is as follows.

At step 100, the user commands for data retrieval/storage operation to the confidential block 122 of the memory card 1 via the host end 2.

At step 110, the memory card control unit 111 of the memory card 1 requests the host end 2 to input the user's key.

At step 120, the user input the key via the host end 2 to the smartcard engine 112 of the memory card 1.

At step 130, the smartcard engine 112 matches the user's key with the key stored in the hidden block 121, if the keys match, the process proceeds to step 140; otherwise, the process returns to step 110.

At step 140, the host end 2 starts processing data retrieval/storage operation to the confidential block 122, and the smartcard engine 122 starts encrypting/decrypting the data.

The memory card with identifier of the present invention has several improvements over the conventional art. The present invention uses the smartcard engine 112 installed in the microcontroller 11 of the memory card 1 to match the key inputted by the user via the host end 2 with the key stored in the flash memory 12, if the key matches, the host end 2 is allowed to process data retrieval/storage operation to the flash memory 12 of the memory card 1. Meanwhile, the smartcard engine 112 encrypts/decrypts the data to prevent the data from being stolen from the flash memory 12 of the memory card 1. Thus, the security of the memory card 1 can be effectively promoted.

A prototype of memory card with identifier has been constructed with the features of FIG. 1˜3. The memory card with identifier functions smoothly to provide all of the features discussed earlier.

Although a particular embodiment of the invention has been described in detail for purposes of illustration, various modifications and enhancements may be made without departing from the spirit and scope of the invention.

What is claimed is:

1. A memory card with identifier, comprising:
a microcontroller, connected to a flash memory transmission interface and a memory card transmission interface, wherein said memory card transmission interface is further connected to a host end; and
a flash memory, connected to said flash memory transmission interface, wherein said microcontroller comprises a memory card control unit for receiving and executing command from said host end and a flash memory control unit for controlling said flash memory, wherein said microcontroller comprises a smartcard engine for matching a key of said host end with a key stored in said flash memory, wherein when said keys of said host end and said flash memory matches, said smartcard engine processes encrypting/decrypting of data to said flash memory, and wherein when said keys of said host end and said flash memory mismatches, said memory card rejects said host end from processing retrieval/storage of data to said flash memory.

2. The memory card with identifier according to claim 1, wherein said flash memory comprises a hidden block and a confidential block; said hidden block is adopted for denying a user to retrieve/store data therein, and said confidential block requires matching of said key of said host end with said key stored in said flash memory by said smartcard engine.

3. The memory card with identifier according to claim 1, wherein said flash memory comprises a general block for allowing retrieval/storage operation.

4. The memory card with identifier according to claim 1, wherein a format of encrypting/decrypting by said smartcard engine is comprised of advanced encryption standard.

5. The memory card with identifier according to claim 1, wherein a format of encrypting/decrypting by said smartcard engine is comprised of data encryption standard.

6. The memory card with identifier according to claim 1, wherein a format of encrypting/decrypting by said smartcard engine is comprised of Rivest Shamir Adleman encryption (RSA).

7. The memory card with identifier according to claim 1, wherein a format of encrypting/decrypting by said smartcard engine is comprised of triple data encryption algorithm.

8. The memory card with identifier according to claim 1, wherein said flash memory comprises a NOR type.

9. The memory card with identifier according to claim 1, wherein said flash memory comprises a NAND type.

10. The memory card with identifier according to claim 1, wherein said flash memory comprises a AND type.

11. The memory card with identifier according to claim 1, wherein said memory card comprises a secure digital (SD) card.

12. The memory card with identifier according to claim 1, wherein said memory card comprises a multi media (MMC) card.

13. The memory card with identifier according to claim 1, wherein said memory card comprises a compact flash (CF) card.

14. The memory card with identifier according to claim 1, wherein said host end comprises a computer.

15. The memory card with identifier according to claim 1, wherein said host end comprises a cellular phone.

16. The memory card with identifier according to claim 1, wherein said host end comprises a PDA.
